(19) United States
(12) Patent Application Publication
(10) Pub. No.: US 2025/0158046 A1
(43) Pub. Date: May 15, 2025

(54) LITHIUM ION SECONDARY BATTERY

(71) Applicant: TOYOTA JIDOSHA KABUSHIKI KAISHA, Toyota-shi (JP)

(72) Inventors: Ryo ASAKURA, Sunto-gun (JP); Shinya SHIOTANI, Nagoya-shi (JP); Sakina KANEKO, Fujisawa-shi (JP)

(73) Assignee: TOYOTA JIDOSHA KABUSHIKI KAISHA, Toyota-shi (JP)

(21) Appl. No.: 18/932,085

(22) Filed: Oct. 30, 2024

(30) Foreign Application Priority Data
Nov. 14, 2023 (JP) 2023-193415

(51) Int. Cl. H01M 4/40; H01M 4/02; H01M 4/134; H01M 4/36; H01M 10/0525; H01M 10/0562

(52) U.S. Cl. CPC H01M 4/405; H01M 4/134; H01M 4/366; H01M 10/0525; H01M 10/0562; H01M 2004/027; H01M 2004/028; H01M 2300/0068

(57) ABSTRACT

To provide a lithium ion secondary battery configured to suppress a decrease in charge capacity. A lithium ion secondary battery, wherein the lithium ion secondary battery uses a lithium metal precipitation-dissolution reaction; wherein the lithium ion secondary battery comprises a cathode layer, an anode layer, and an electrolyte layer disposed between the cathode layer and the anode layer; wherein the cathode layer contains a cathode active material that can occlude and release a lithium ion; and wherein the anode layer contains a Mg element, an In element, a Sn element and a Li element.

### TECHNICAL FIELD

The disclosure relates to a lithium ion secondary battery.

### BACKGROUND

Various techniques have been proposed in regard to a lithium ion secondary battery as disclosed in Patent Document 1, in which the anode contains a metal layer.
Patent Document 1: Japanese Patent Application Laid-Open (JP-A) No. 2021-068706
Patent Document 2: JP-A No. 2020-191202

### SUMMARY

In the prior art, since the resistance of the anode layer of a lithium ion secondary battery increases at the end of discharge, the reversible capacity of the lithium ion secondary battery decreases along with repeated charge and discharge.

The present disclosure was achieved in light of the above circumstances. A main object of the present disclosure is to provide a lithium ion secondary battery configured to suppress a decrease in charge capacity.

The embodiments of the present disclosure include the following <1> to <6>.

<1> A lithium ion secondary battery,
wherein the lithium ion secondary battery uses a lithium metal precipitation-dissolution reaction;
wherein the lithium ion secondary battery comprises a cathode layer, an anode layer, and an electrolyte layer disposed between the cathode layer and the anode layer;
wherein the cathode layer contains a cathode active material that can occlude and release a lithium ion; and
wherein the anode layer contains a Mg element, an In element, a Sn element and a Li element.

<2> The lithium ion secondary battery according to <1>, wherein a molar ratio (Sn/In) of the Sn element to the In element contained in the anode layer is 0.5 or more and 3.8 or less.

<3> The lithium ion secondary battery according to <1> or <2>, wherein the anode layer comprises, in the order closest to the electrolyte layer side, a Li—In—Sn alloy layer containing a Li—In—Sn alloy and a Li—Mg alloy layer containing a Li—Mg alloy.

<4> The lithium ion secondary battery according to any one of <1> to <3>,
wherein the lithium ion secondary battery comprises an anode current collector on the opposite side of the electrolyte layer of the anode layer, and
wherein, when the anode layer is divided into two equal parts in parallel to a laminated surface of the anode layer and an anode current collector-side region and an electrolyte layer-side region are determined as a first region and a second region, respectively, a content of the In and Sn elements in the second region of the anode layer is larger than a content of the In and Sn elements in the first region of the anode layer.

<5> The lithium ion secondary battery according to any one of <1> to <4>, wherein the electrolyte layer is a solid electrolyte layer containing a sulfide-based solid electrolyte.

<6> A lithium ion secondary battery,
wherein the lithium ion secondary battery uses a lithium metal precipitation-dissolution reaction;
wherein the lithium ion secondary battery comprises a cathode layer, an anode layer, and an electrolyte layer disposed between the cathode layer and the anode layer;
wherein the cathode layer contains a cathode active material that can occlude and release a lithium ion; and
wherein the anode layer comprises, in the order closest to the electrolyte layer, an In—Sn alloy layer containing an In—Sn alloy and a Mg metal layer containing elemental Mg.

The lithium ion secondary battery of the present disclosure can suppress a decrease in charge capacity.

### BRIEF DESCRIPTION OF THE DRAWINGS

FIG. 1 is a schematic sectional view of an example of the lithium ion secondary battery of the present invention before initial charge during production.

FIG. 2 is a schematic sectional view of an example of the fully charged lithium ion secondary battery of the present invention after the initial charge.

FIG. 3 is a graph showing a relationship between the Sn composition of an In—Sn alloy and the resistance of a laminate cell after initial charge and discharge.

FIG. 4 is a graph showing a relationship between the current density and charge capacity at 25° C. of each of the laminate cells of Examples 1 to 3 and Comparative Examples 1, 7 and 8 after initial charge and discharge.

FIG. 5 is a graph showing a relationship between the Sn composition of an In—Sn alloy and the 25° C. charge capacity at a 2 C rate of a laminate cell after initial charge and discharge.

FIG. 6 shows the following in SEM-EDX mapping of a section of a stack of a solid electrolyte layer and an anode included in the laminate cell of Example 2 after initial charge: (1) a secondary electron image, (2) S element mapping, (3) In element mapping, (4) Sn element mapping, (5) O element mapping, (6) Mg element mapping and (7) Ni element mapping.

FIG. 7 shows the following in SEM-EDX mapping of a section of a stack of a solid electrolyte layer and an anode included in the laminate cell of Example 2 after initial discharge: (1) a secondary electron image, (2) S element mapping, (3) In element mapping, (4) Sn element mapping, (5) O element mapping, (6) Mg element mapping and (7) Ni element mapping.

### DETAILED DESCRIPTION

Hereinafter, the embodiments of the present disclosure will be described in detail. Matters that are required to implement the present disclosure (such as common lithium ion secondary battery structures and production processes not characterizing the present disclosure) other than those specifically referred to in this description, may be understood as design matters for a person skilled in the art based on conventional techniques in the art. The present disclosure can be implemented based on the contents disclosed in this description and common technical knowledge in the art.

In the present disclosure, there is provided a lithium ion secondary battery,
wherein the lithium ion secondary battery uses a lithium metal precipitation-dissolution reaction;
wherein the lithium ion secondary battery comprises a cathode layer, an anode layer, and an electrolyte layer disposed between the cathode layer and the anode layer;
wherein the cathode layer contains a cathode active material that can occlude and release a lithium ion; and
wherein the anode layer contains a Mg element, an In element, a Sn element and a Li element.

In the present disclosure, an increase in the resistance of the anode layer at the end of discharge can be suppressed, and a decrease in n charge-discharge efficiency can be suppressed.

In the present disclosure, the Li—In—Sn alloy layer is formed between the electrolyte layer and a Li—Mg alloy layer during Li intercalation in the anode layer. Accordingly, the removal of the anode layer from the electrolyte layer can be suppressed, and compared to the case where the Li—Mg alloy layer is not present or the case where a Li—In alloy layer or a Li—Sn alloy layer is used between the electrolyte layer and the Li—Mg alloy layer, the reversible capacity of the lithium ion secondary battery increases, and the charge-discharge efficiency thereof improves.

When In and Sn are mixed, compared to the case of using elemental Sn, the melting point of the In—Sn alloy decreases lower than that of elemental Sn; the adhesion between the electrolyte layer and the anode layer improves; and a decrease in the charge-discharge efficiency of the lithium ion secondary battery can be suppressed.

The lithium ion secondary battery of the present disclosure uses a lithium metal precipitation-dissolution reaction.

The lithium ion secondary battery comprises a cathode layer, an anode layer, and an electrolyte layer disposed between the cathode layer and the anode layer.

In the disclosed embodiments, “fully charged lithium ion secondary battery” means that the SOC (state of charge) value of the lithium ion secondary battery is 100%. The SOC means the percentage of the charge capacity with respect to the full charge capacity of the battery. The full charge capacity is a SOC of 100%.

For example, the SOC may be estimated from the open circuit voltage (OCV) of the lithium ion secondary battery.

### [Anode]

The anode includes the anode layer. As needed, the anode includes the anode current collector.

### [Anode Current Collector]

The material for the anode current collector may be a material that is not alloyed with Li, such as SUS, copper and nickel. As the form of the anode current collector, examples include, but are not limited to, a foil form and a plate form. The plan-view shape of the anode current collector is not particularly limited, and examples thereof include, but are not limited to, a circular shape, an ellipse shape, a rectangular shape and any arbitrary polygonal shape. The thickness of the anode current collector varies depending on the shape. For example, it may be in a range of from 1 μm to 50 μm, or it may be in a range of from 5 μm to 20 μm.

### [Anode Layer]

The anode layer contains a Mg element, an In element, a Sn element and a Li element.

Before initial charge of the lithium ion secondary battery, the anode layer may comprise, in the order closest to the electrolyte layer, an In—Sn alloy layer containing an In—Sn alloy and a Mg metal layer containing elemental Mg.

After initial charge of the lithium ion secondary battery, the anode layer may comprise, in the order closest to the electrolyte layer side, a Li—In—Sn alloy layer containing a Li—In—Sn alloy and a Li—Mg alloy layer containing a Li—Mg alloy.

The molar ratio {(In+Sn)/Mg} of the total of the In and Sn elements to the Mg element contained in the anode layer may be 0.01 or more, or it may be 0.0872 or more. When the molar ratio is less than 0.01, the content of the In and Sn elements in the anode layer is too small and leads to a decrease in charge capacity.

The molar ratio (Sn/In) of the Sn element to the In element contained in the anode layer may be 0.5 or more and 3.8 or less.

When the anode layer is divided into two equal parts in parallel to the laminated surface of the anode layer and the anode current collector-side region and the electrolyte layer-side region are determined as the first region and the second region, respectively, the content of the In and Sn elements in the second region of the anode layer may be larger than the content of the In and Sn elements in the first region of the anode layer. The anode layer may be divided into two equal parts in approximately parallel to the laminated surface. The “approximately parallel” may be in a range of from 0° to 10°. The lamination direction of the anode layer is the thickness direction of the anode layer.

For the comparison of the contents of the two regions in the anode layer, for example, elemental mapping aimed at observing the electrolyte layer to the anode current collector may be carried out by SEM-EDX, and then the contents of the target elements in the regions may be compared to each other. The comparison of the contents of the two regions in the anode layer may be carried out on the lithium ion secondary battery in a fully charged condition or the like upon initial and subsequent charges. The comparison of the contents is not limited to this, and it may be carried out by XPS, TOF-SIMS or the like, besides SEM-EDX.

In the lithium ion secondary battery before initial charge during production, the Sn composition ratio of the In—Sn alloy layer may be more than 0 mol % and less than 100 mol %; the lower limit may be 20 mol % or more; and the upper limit may be 80 mol % or less, may be 70 mol % or less, or may be 60 mol % or less.

In the lithium ion secondary battery after initial charge, the thickness of the Li—In—Sn alloy layer may be more than 0 μm and 100 μm or less; the lower limit may be 0.01 μm or more, or it may be 0.1 μm or more; and the upper limit may be 15 μm or less, may be 0.6 μm or less, or may be 0.35 μm or less.

In the lithium ion secondary battery after initial charge, the Li composition ratio of the Li—Mg alloy layer may be more than 0 mol % and less than 100 mol %; the lower limit may be 20 mol % or more; and the upper limit may be 98 mol % or less.

In the lithium ion secondary battery after initial charge, the thickness of the Li—Mg alloy layer may be more than 0 μm and 100 μm or less; the lower limit may be 0.1 μm or more; and the upper limit may be 40 μm or less.

The Mg metal layer is formed on the anode current collector, for example. As the method for forming the Mg metal layer, examples include, but are not limited to, the deposition method, the sputtering method, the PVD method, the electrolytic plating method, and the method of placing particles and pressing the placed particles. Of them, the Mg metal layer forming method may be the deposition or the sputtering. This is because the adhesion between the Mg metal layer and the anode current collector is improved, and an increase in the resistance of the anode can be suppressed.

The In—Sn alloy layer may be formed by the same method on the solid electrolyte layer side or on the anode current collector side. Of them, the In—Sn alloy layer may be formed on the anode current collector side. By forming the In—Sn alloy layer on the anode current collector side, the adhesion between the In—Sn alloy layer and the Mg metal layer improves.

The thickness of the anode layer is not particularly limited. In the fully charged lithium ion secondary battery after initial charge, the anode layer thickness may be 30 nm or more and 50 μm or less.

### [Electrolyte Layer]

The electrolyte layer may be a liquid electrolyte layer using an electrolytic solution as the electrolyte, or it may be a solid electrolyte layer using a solid electrolyte as the electrolyte.

As the electrolytic solution, a conventionally-known electrolytic solution used in lithium ion secondary batteries can be used.

The solid electrolyte layer contains at least a solid electrolyte.

As the solid electrolyte contained in the solid electrolyte layer, a conventionally-known solid electrolyte that is applicable to solid-state batteries can be appropriately used, such as an oxide-based solid electrolyte and a sulfide-based solid electrolyte. To suppress the removal of the anode layer from the solid electrolyte layer, a relatively soft sulfide-based solid electrolyte may be used as the solid electrolyte.

As the sulfide-based solid electrolyte, examples include, but are not limited to, a solid electrolyte containing a Li element, a M element (M is at least one selected from P, As, Sb, Si, Ge, Sn, B, Al, Ga and In) and a S element. The sulfide-based solid electrolyte may further contain at least one of an O element and a halogen element.

As the sulfide-based solid electrolyte, examples include, but are not limited to, Li₂S—P₂S₅, Li₂S—SiS₂, LiX—Li₂S—SiS₂, LiX—Li₂S—P₂S₅, LiX—Li₂O—Li₂S—P₂S₅, LiX—Li₂S—P₂O₅, LiX—Li₃PO₄—P₂S₅ and Li₃PS₄. Note that the description “Li₂S—P₂S” means a material consisting of a raw material composition including Li₂S and P₂S₅, and the same applies to other descriptions.

Also, “X” of the above-described LiX indicates a halogen element. As the halogen element, examples include, but are not limited to, a F element, a Cl element, a Br element and an I element. The raw material composition may contain one or two or more kinds of LiX. When two or more kinds of LiX are contained, the mixing ratio of the two or more kinds of LiX is not particularly limited.

The molar ratio of the elements in the sulfide-based solid electrolyte can be controlled by adjusting the amounts of the elements in the raw material. Also, the molar ratio and composition of the elements in the sulfide-based solid electrolyte can be measured by ICP emission spectrometry, for example.

The sulfide-based solid electrolyte may be a sulfide glass, a crystalline sulfide glass (glass ceramic) or a crystalline material obtained by carrying out a solid-phase reaction treatment on the raw material composition.

The crystal state of the sulfide-based solid electrolyte can be confirmed, for example, by carrying out powder X-ray diffraction measurement using CuKα rays on the sulfide-based solid electrolyte.

The sulfide glass can be obtained by carrying out an amorphous treatment on the raw material composition such as a mixture of Li₂S and P₂S₅. As the amorphous treatment, examples include, but are not limited to, mechanical milling.

The glass ceramic can be obtained, for example, by heat-treating a sulfide glass.

The heat treatment temperature may be a temperature higher than the crystallization temperature (Tc) observed by thermal analysis measurement of the sulfide glass, and it is generally 195° C. or more. On the other hand, the upper limit of the heat treatment temperature is not particularly limited.

The crystallization temperature (Tc) of the sulfide glass can be measured by differential thermal analysis (DTA).

The heat treatment time is not particularly limited, as long as the desired crystallinity of the glass ceramic is obtained. For example, it is within a range of from one minute to 24 hours, and it may be within a range of from one minute to 10 hours.

The heat treatment method is not particularly limited. As the heat treatment method, examples include, but are not limited to, a heat treatment method using a firing furnace.

As the oxide-based solid electrolyte, examples include, but are not limited to, a substance having a garnet-type crystal structure including, for example, a Li element, a La element, an A element (A is at least one of Zr, Nb, Ta and Al) and an O element. The oxide-based solid electrolyte may be Li₂O—B₂O₃—P₂O₅, Li₂O—SiO₂, Li₂O—B₂O₃, Li_{1.3}Al_{0.3}Ti_{0.7}(PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄ or Li₃₊ₓPO₄₋ₓNₓ (1≤x≤3), for example.

The form of the solid electrolyte may be a particulate form, from the viewpoint of good handleability.

The average particle diameter (D50) of the solid electrolyte particles is not particularly limited. The lower limit of the average particle diameter may be 0.5 μm or more, and the upper limit may be 2 μm or less.

In the disclosed embodiments, the average particle diameter of the particles is the value of a volume-based median diameter (D50) measured by laser diffraction and scattering particle size distribution measurement, unless otherwise noted. In the disclosed embodiments, the median diameter (D50) is a diameter (volume average diameter) such that the cumulative volume of the particles is half (50%) of the total volume when the particles are arranged in order of particle diameter from smallest to largest.

The solid electrolyte may be one kind of solid electrolyte, or it may be 2 or more kinds of solid electrolytes. In the case of using 2 or more kinds of solid electrolytes, they may be mixed together, or they may be formed into layers to obtain a multilayer structure.

The amount of the solid electrolyte in the solid electrolyte layer is not particularly limited. For example, it may be 50 mass % or more; it may be within a range of 60 mass % or more and 100 mass % or less; it may be within a range of 70 mass % or more and 100 mass % or less; or it may be 100 mass %.

A binder may also be contained in the solid electrolyte layer, from the viewpoint of expressing plasticity, etc. As the binder, examples include, but are not limited to, materials exemplified below as the binder used in the cathode layer described below. However, to facilitate high output, the binder contained in the solid electrolyte layer may be 5 mass % or less, from the viewpoint of preventing excessive aggregation of the solid electrolyte and enabling the formation of the solid electrolyte layer in which the solid electrolyte is uniformly dispersed.

The thickness of the solid electrolyte layer is not particularly limited. In general, it is 0.1 μm or more and 1 mm or less.

### [Cathode]

The cathode includes the cathode layer. As needed, the cathode includes a cathode current collector.

### [Cathode Layer]

The cathode layer contains a cathode active material that can occlude and release a lithium ion. As optional components, the cathode layer may contain a solid electrolyte, a conductive material, a binder, etc.

The cathode active material may contain the Li element before the lithium ion secondary battery is initially charged. As the cathode active material, examples include, but are not limited to, lithium nickel cobalt aluminum oxide (NCA), LiCoO₂, LiNiₓCO₁₋ₓO₂ (0<x<1), LiNi_{1/3}Co_{1/3}Mn_{1/3}O₂, LiMnO₂, LiMn₂O₄, LiNiO₂, LiVO₂, a different element-substituted Li—Mn spinel, lithium titanate, lithium metal phosphate, LiCON, Li₂SiO₃ and Li₄SiO₄. As the different element-substituted Li—Mn spinel, examples include, but are not limited to, LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄. As the lithium titanate, examples include, but are not limited to, Li₄Ti₅O₁₂. As the lithium metal phosphate, examples include, but are not limited to, LiFePO₄, LiMnPO₄, LiCoPO₄ and LiNiPO₄.

The form of the cathode active material is not particularly limited. It may be a particulate form (cathode active material particles).

On the surface of the cathode active material, a coating layer containing a Li ion conductive oxide may be formed. This is because a reaction between the cathode active material and the solid electrolyte can be suppressed.

As the Li ion conductive oxide, examples include, but are not limited to, LiNbO₃, Li₄Ti₅O₁₂, and Li₃PO₄. The thickness of the coating layer is, for example, 0.1 nm or more, and it may be 1 nm or more. On the other hand, the thickness of the coating layer is, for example, 100 nm or less, and it may be 20 nm or less. The coating rate of the coating layer on the surface of the cathode active material is, for example, 70% or more, and it may be 90% or more.

As the solid electrolyte, examples include, but are not limited to, a solid electrolyte that can be contained in the solid electrolyte layer described above.

The content of the solid electrolyte in the cathode layer is not particularly limited. It may be within a range of, for example, from 1 mass % to 80 mass % of the total mass (100 mass %) of the cathode layer.

As the conductive material, a known material can be used, such as a carbon material and metal particles. As the carbon material, examples include, but are not limited to, acetylene black (AB), furnace black, VGCF, carbon nanotube and carbon nanofiber. Among them, at least one selected from the group consisting of VGCF, carbon nanotube and carbon nanofiber may be used, from the viewpoint of electron conductivity. As the metal particles, examples include, but are not limited to, particles of Ni, Cu, Fe and SUS.

The content of the conductive material in the cathode layer is not particularly limited.

As the binder, examples include, but are not limited to, acrylonitrile butadiene rubber (ABR), butadiene rubber (BR), polyvinylidene fluoride (PVdF), polytetrafluoroethylene (PTFE) and styrene butadiene rubber (SBR). The content of the binder in the cathode layer is not particularly limited.

The thickness of the cathode layer is not particularly limited.

The cathode layer can be formed by a conventionally known method.

For example, the cathode active material and, as needed, other components are put in a solvent; they are stirred to prepare a slurry for a cathode layer; and the slurry for the cathode layer is applied on one surface of a support such as a cathode current collector; and the applied slurry is dried, thereby obtaining the cathode layer.

As the solvent, examples include, but are not limited to, butyl acetate, butyl butyrate, heptane, and N-methyl-2-pyrrolidone.

The method for applying the slurry for the cathode layer on one surface of the support such as the cathode current collector, is not particularly limited. As the method, examples include, but are not limited to, the doctor blades method, the metal mask printing method, the static coating method, the dip coating method, the spread coating method, the roll coating method, the gravure coating method, and the screen printing method.

As the support, one having self-supporting property can be appropriately selected and used without particular limitation. For example, a metal foil such as Cu and Al can be used.

### [Cathode Current Collector]

As the cathode current collector, a known metal that can be used as the current collector of a lithium ion secondary battery, can be used. As the metal, examples include, but are not limited to, a metal m material containing one or more elements selected from the group consisting of Cu, Ni, Al, V, Au, Pt, Mg, Fe, Ti, Co, Cr, Zn, Ge and In. As the cathode current collector, examples include, but are not limited to, SUS, aluminum, nickel, iron, titanium and carbon.

The form of the cathode current collector is not particularly limited. As the form, examples include, but are not limited to, various kinds of forms such as a foil form and a mesh form.

As needed, the lithium ion secondary battery includes an outer casing for housing the cathode layer, the anode layer, the solid electrolyte layer, etc.

The material for the outer casing is not particularly limited, as long as it is a material stable in electrolyte. As the material, examples include, but are not limited to, a resin such as polypropylene, polyethylene and acrylic resin.

As the form of the lithium ion secondary battery, examples include, but are not limited to, a coin form, a laminate form, a cylindrical form and a square form.

The lithium ion secondary battery may be a liquid lithium ion secondary battery using an electrolytic solution as the electrolyte, or it may be a solid lithium ion secondary battery using a solid electrolyte as the electrolyte. As the applications of the lithium ion secondary battery, examples include, but are not limited to,
the power sources of vehicles such as a hybrid electric vehicle (HEV), a plug-in hybrid electric vehicle (PHEV), a battery electric vehicle (BEV), a gasoline vehicle and diesel vehicle. Especially, the lithium ion secondary battery may be used in the driving power supply of a hybrid electric vehicle (HEV), a plug-in hybrid electric vehicle (PHEV) or a battery electric vehicle (BEV). Also, the lithium ion secondary battery may be used as the powder source of mobile objects other than vehicles, such as railroads, ships and aircrafts, or it may be used as the power source of electrical appliances such as an information processing device.

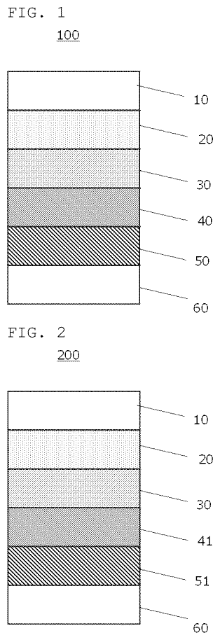

FIG. 1 is a schematic sectional view of an example of the lithium ion secondary battery of the present invention before initial charge during production.

As shown in FIG. 1, a lithium ion secondary battery 100 before initial charge comprises a cathode current collector 10, a cathode layer 20, an electrolyte layer 30, an In—Sn alloy layer 40, a Mg metal layer 50 and an anode current collector 60 in this order. The anode layer includes an In—Sn alloy layer 40 and a Mg metal layer 50.

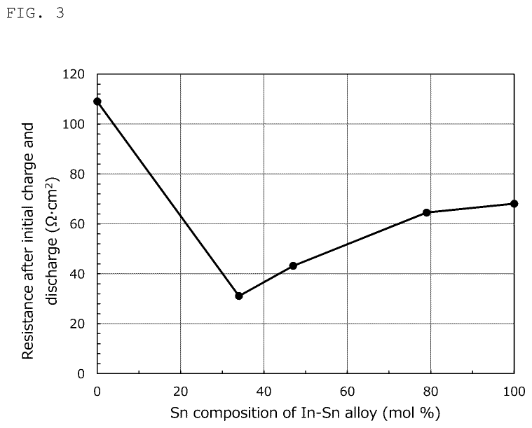

FIG. 2 is a schematic sectional view of an example of the fully charged lithium ion secondary battery of the present invention after the initial charge.

As shown in FIG. 2, a lithium ion secondary battery 200 after initial charge comprises a cathode current collector 10, a cathode layer 20, an electrolyte layer 30, a Li—In—Sn alloy layer 41, a Li—Mg alloy layer 51 and an anode current collector 60 in this order. By initial charge, the In—Sn alloy layer 40 is turned into the Li—In—Sn alloy layer 41, and the Mg metal layer 50 is turned into the Li—Mg alloy layer 51. The anode layer includes the Li—In—Sn alloy layer 41 and the Li—Mg alloy layer 51.

### EXAMPLES

### Examples 1 to 3

### [Production of Cathode]

Butyl butyrate was used as a solvent. NCA was used as a cathode active material. sulfide-based solid electrolyte particles (average particle diameter: 2.0 μm) were used as a solid electrolyte. An Al foil was used as a cathode current collector. The cathode active material, the solid electrolyte, a binder and a conductive additive were mixed at a mass composition ratio of 84.7:13.4:0.6:1.27 in the solvent, thereby producing a cathode slurry.

The produced cathode slurry was applied onto the Al foil with a coating gap of 225 μm. Then, the applied cathode slurry was subjected to preliminary drying at 60° C. for three hours. Next, the preliminarily dried cathode slurry was subjected to main drying at 165° C. for one hour. Accordingly, a cathode mixture coated foil having a coating amount of 18.7 mg/cm² and a design capacity of 3.0 mAh/cm² was obtained. The obtained cathode mixture coated foil was cut to obtain a cathode having a diameter of 11.28 mm.

### [Production of Solid Electrolyte Layer]

Butyl butyrate was used as a solvent. sulfide-based solid electrolyte particles (average particle diameter: 2.0 μm) were used as a solid electrolyte. The solid electrolyte and a binder were mixed in the solvent at a mass composition ratio of 92.6:7.4, thereby obtaining a solid electrolyte slurry.

The produced solid electrolyte slurry was applied onto a release film with a coating gap of 325 μm. Then, the applied solid electrolyte slurry was subjected to preliminary drying at room temperature for three hours. Then, the preliminarily dried solid electrolyte slurry was subjected to main drying at 165° C. for one hour. A dried solid electrolyte coated foil thus obtained was cut to obtain two disks having a diameter of 14.5 mm. The solid electrolyte-coated surfaces of the two disks were stacked, and the disks were pressed at 7 t. After the press, the release films of the two disks were removed therefrom to obtain a self-supporting solid electrolyte layer.

### [Production of Anode]

A Ni foil was used as an anode current collector. A Mg metal layer having a thickness of 1.0 μm was formed on one surface of the anode current collector by deposition to obtain a stack of the Mg metal layer and the Ni foil. An In—Sn alloy layer having a thickness of 0.1 μm was formed on the Mg metal layer of the Mg metal layer/Ni foil stack by binary deposition by the ion plating method. Accordingly, an In—Sn alloy layer/Mg metal layer/Ni foil stack was produced. The obtained In—Sn alloy layer/Mg metal layer/Ni foil stack was cut to obtain an anode having a diameter of 14.5 mm. The targeted composition (mol %) of the In—Sn alloy was 67:33 in Example 1, 50:50 in Example 2, and 20:80 in Example 3. The actual composition (mol %) of the In—Sn alloy was 66:34 in Example 1, 53:47 in Example 2, and 21:79 in Example 3.

### [Production of Cell]

Al was used as a cathode tab. Ni was used as an anode tab.

The produced solid electrolyte layer was disposed between the produced cathode and the produced abode to obtain a laminate. The cathode tab was attached to the cathode, and the anode tab was attached to the anode. Then, the laminate was housed in a laminate film bag, and vacuum was drawn inside the laminate film bag to encapsulate the laminate. The encapsulated laminate was subjected to cold isostatic press (CIP) at 392 MPa to produce a laminate cell (hereinafter may be referred to as “cell”). The produced laminate cell was fixed at 1 MPa by use of a constant-pressure jig, in which a spring was inserted, to keep the fixing pressure constant despite a change in the volume of the laminate cell.

### Comparative Example 1

The laminate cell of Comparative Example 1 was produced in the same manner as Example 1, except that a Mg metal layer/Ni foil stack was used as the anode.

### Comparative Example 2

The laminate cell of Comparative Example 2 was produced in the same manner as Example 1, except that a Mg metal layer was not used; an In metal layer having a thickness of 0.1 μm was formed on the anode current collector by deposition; and the In metal layer/Ni foil stack was used as the anode.

### Comparative Example 3

The laminate cell of Comparative Example 3 was produced in the same manner as Example 1, except that a Mg metal layer was not used; a Sn metal layer having a thickness of 0.1 μm was formed on the anode current collector by deposition; and the Sn metal layer/Ni foil stack was used as the anode.

### Comparative Examples 4 to 6

The laminate cells of Comparative Examples 4 to 6 were produced in the same manner as Example 1, except that a Mg metal layer was not used; an In—Sn alloy layer having a thickness of 0.1 μm was formed by binary deposition by the ion plating method on the produced solid electrolyte layer; and the In—Sn alloy layer/Ni foil stack was used as the anode. The actual composition (mol %) of the In—Sn alloy was 62:38 in Comparative Example 4, 49:51 in Comparative Example 5, and 38:62 in Comparative Example 6.

### Comparative Example 7

The laminate cell of Comparative Example 7 was produced in the same manner as Example 1, except that an In layer having a thickness of 0.1 μm was formed on the produced solid electrolyte layer by sputtering, and the In metal layer/Mg metal layer/Ni foil stack was used as the anode.

### Comparative Example 8

The laminate cell of Comparative Example 8 was produced in the same manner as Example 1, except that a Sn layer having a thickness of 0.1 μm was formed on the produced solid electrolyte layer by sputtering, and the Sn metal layer/Mg metal layer/Ni foil stack was used as the anode.

### [Molar Ratio (In—Sn/Mg)]

For each of the anode layers of Examples 1 to 3 and Comparative Examples 7 and 8, the molar ratio {(In+Sn)/Mg} of the total of the In and Sn elements to the Mg element contained in the anode layer was calculated. The results are shown in Table 1.

### [Initial Charge and Discharge]

In the following conditions, the initial charge and discharge of each of the laminate cells produced in Examples 1 to 3 and Comparative Examples 1 to 8 were carried out at 60° C.

Constant current charge of the laminate cell was carried out at a current density of 0.15 mA/cm² and a 0.05 C rate until the laminate cell reached a voltage of 4.2 V. Then, constant voltage charge of the laminate cell was carried out until the laminate cell reached a current density of 0.03 mA/cm² and a 0.01 C rate.

Constant current discharge of the laminate cell was carried out at a current density of 0.15 mA/cm² and a 0.05 C rate until the laminate cell reached a voltage of 3.0 V. Then, constant voltage discharge of the laminate cell was carried out until the laminate cell reached a current density of 0.03 mA/cm² and a 0.01 C rate.

[Resistance after Initial Charge and Discharge]

The resistance (Ω·cm²) of each of the laminate cells of Examples 1 to 3 and Comparative Examples 1, 7 and 8 after initial charge and discharge, when a predetermined current was applied to the laminate cell for one second at a predetermined voltage, was measured by the AC impedance method. The results are shown in Table 1.

FIG. 3 is a graph showing a relationship between the Sn composition of the In—Sn alloy and the resistance of the laminate cell after initial charge and discharge.

The resistance of each of the laminate cells of Examples 1 to 3 after initial charge and discharge, decreases in the following order: Example 3, Example 2 and Example 1. The cell resistance at the end of discharge was suppressed compared to Comparative Example 7 in which elemental In was used in the second layer of the anode layer and Comparative Example 8 in which elemental Sn was used in the second layer of the anode layer.

It is presumed that each of the anodes of Examples 1 to 3 during production was a mixture of several kinds of In—Sn alloys such as InSn₄, InSn and In₃Sn. Accordingly, it is presumed that during Li intercalation in the anode layer by cell charging, an increase in the melting point of the In—Sn alloy derived from Sn was reduced by alloying Li with the In—Sn alloy, and the cell resistance decreased, accordingly.

### [25° C. Charge Capacity]

In the following conditions, the charge capacity (mAh/cm²) of each of the laminate cells of Examples 1 to 3 and Comparative Examples 1, 7 and 8 after initial charge and discharge was measured at 25° C., while keeping the current density during discharge at 0.15 mA/cm², keeping the 0.05 C rate the same, and changing only the current density during charge from cycle to cycle.

Constant current charge of the laminate cell was carried out at a current density of 6.0 mA/cm² and a 2 C rate until the laminate cell reached a voltage of 4.2 V. Then, the charge capacity of the laminate cell was measured. The results are shown in Table 1.

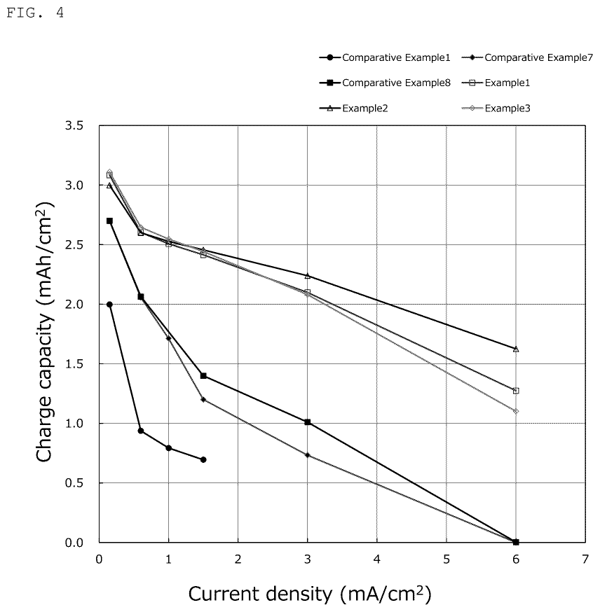

FIG. 4 is a graph showing a relationship between the current density and charge capacity at 25° C. of each of the laminate cells of Examples 1 to 3 and Comparative Examples 1, 7 and 8 after initial charge and discharge.

FIG. 4 shows that the 25° C. charge capacities of Examples 1 to 3 at every C rate are large compared to Comparative Examples 1, 7 and 8.

As shown in Table 1, due to an improvement in the adhesion between the electrolyte layer and the anode layer, the laminate cells of Examples 1 to 3 after initial charge and discharge prevent short circuits during cell charging at a 2 C rate.

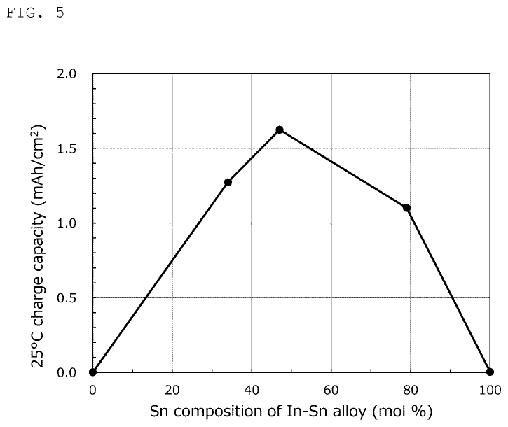

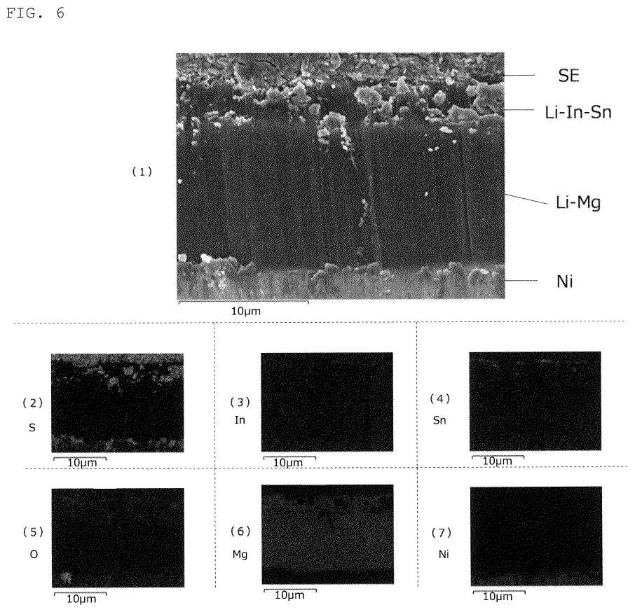

FIG. 5 is a graph showing a relationship between the Sn composition of the In—Sn alloy and the 25° C. charge capacity at a 2 C rate of the laminate cell after initial charge and discharge.

The charge capacities at a 2 C rate of the laminate cells of Examples 1 to 3 shown in FIG. 5 and Table 1 increase in the following order: Example 3, Example 1 and Example 2.

In the Li—In—Sn alloy, the In-rich composition showed a higher charge capacity than the Sn-rich composition. This is considered because the lithium ion conducting path activation energy of the Li—In alloy is generally lower than that of the Li—Sn alloy.

TABLE 1

| | | | 25° C. charge | |
|---|---|---|---|---|
| | Anode layer structure | Resistance after initial | capacity when charged | |
| | before initial charge | charge and discharge | at 2 C rate | In—Sn/Mg |
| | (mol %) | (Ω · cm²) | (mAh/cm²) | Molar ratio |
| Comparative | Mg | 377 | Short circuit | — |
| Example 1 | | | | |
| Comparative | In—Mg | 109 | 0.000518 | 0.0890 |
| Example 7 | | | | |
| Comparative | Sn—Mg | 68 | 0.00333 | 0.0861 |
| Example 8 | | | | |
| Example 1 | In:Sn (66:34)-Mg | 31 | 1.27 | 0.0880 |
| Example 2 | In:Sn (53:47)-Mg | 43 | 1.62 | 0.0877 |
| Example 3 | In:Sn (21:79)-Mg | 65 | 1.10 | 0.0872 |

[Reversible Capacity after 20 Cycles]

In the following conditions, the reversible capacity (mAh/cm²) after 20 cycles of each of the laminate cells of Examples 1 to 3 and Comparative Examples 1 to 8 after initial charge and discharge, was measured at 25° C.

Constant current charge of the laminate cell was carried out at a current density of 0.60 mA/cm² and a 0.2 C rate until the laminate cell reached a voltage of 4.2 V. Then, constant voltage charge of the laminate cell was carried out until the laminate cell reached a current density of 0.03 mA/cm² and a 0.01 C rate.

Constant current discharge of the laminate cell was carried out at a current density of 0.60 mA/cm² and a 0.2 C rate until the laminate cell reached a voltage of 3.0 V. This charge and discharge was determined as one cycle, and a total of 20 cycles were repeated. The reversible capacity (discharge capacity) after 20 cycles was measured. The results are shown in Table 2.

As for the reversible capacity after 20 cycles, Table 2 shows the following results: the difference between Examples 1 to 3 is small, and the reversible capacity of Example 2 is the largest. Compared to Comparative Example 7 in which elemental In was used in the second layer of the anode layer and Comparative Example 8 in which elemental Sn was used in the second layer of the anode layer, Examples 1 to 3 showed an improvement in the reversible capacity.

TABLE 2

| | Anode layer structure | 25° C. reversible |
|---|---|---|
| | before initial charge | capacity after 20 cycles |
| | (mol %) | (mAh/cm²) |
| Comparative | Mg | 0.81 |
| Example 1 | | |
| Comparative | In | 1.26 |
| Example 2 | | |
| Comparative | Sn | 0.80 |
| Example 3 | | |
| Comparative | In:Sn (62:38) | 1.48 |
| Example 4 | | |
| Comparative | In:Sn (49:51) | 1.44 |
| Example 5 | | |
| Comparative | In:Sn (38:62) | 1.40 |
| Example 6 | | |
| Comparative | In—Mg | 2.02 |
| Example 7 | | |
| Comparative | Sn—Mg | 2.05 |
| Example 8 | | |
| Example 1 | In:Sn (66:34)-Mg | 2.26 |
| Example 2 | In:Sn (53:47)-Mg | 2.37 |
| Example 3 | In:Sn (21:79)-Mg | 2.11 |

### [SEM-EDX Measurement]

At an impressed voltage of 5 kV, SEM observation and EDX mapping with a secondary electron image were carried out on a section of the stack of the solid electrolyte layer and the anode (the Li—In—Sn alloy layer/the Li—Mg alloy layer/the Ni foil) included in the laminate cell of Example 2 after initial charge.

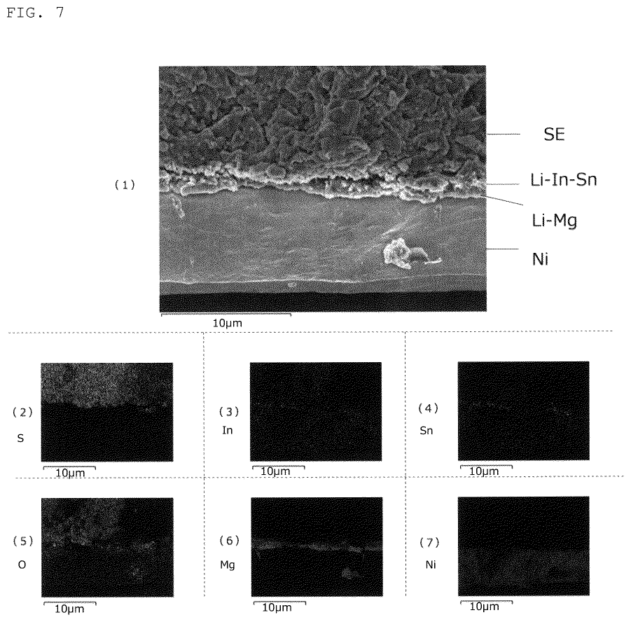

FIG. 6 shows the following in SEM-EDX mapping of the section of the stack of the solid electrolyte layer and the anode included in the laminate cell of Example 2 after initial charge: (1) a secondary electron image, (2) S element mapping, (3) In element mapping, (4) Sn element mapping, (5) 0 element mapping, (6) Mg element mapping and (7) Ni element mapping.

At an impressed voltage of 5 kV, SEM observation and EDX mapping with a secondary electron image were carried out on a section of the stack of the solid electrolyte layer and the anode (the Li—In—Sn alloy layer/the Li—Mg alloy layer/the Ni foil) included in the laminate cell of Example 2 after initial discharge.

FIG. 7 shows the following in SEM-EDX mapping of the section of the stack of the solid electrolyte layer and the anode included in the laminate cell of Example 2 after initial discharge: (1) a secondary electron image, (2) S element mapping, (3) In element mapping, (4) Sn element mapping, (5) O element mapping, (6) Mg element mapping and (7) Ni element mapping.

As is clear from in FIG. 6, when the anode layer is divided into two equal parts (the anode current collector-side region and the electrolyte layer-side region), the content of the In and Sn elements in the electrolyte layer-side region is larger than the content of the In and Sn elements in the anode current collector-side region.

As is clear from FIG. 6, the Li—In—Sn alloy layer was formed between the solid electrolyte layer and the Li—Mg alloy layer. It was confirmed that the Li—Mg alloy layer was widely distributed; much of the Li reacted with the Mg; and the Li—Mg alloy layer functioned as a Li reaction layer.

As is clear from FIG. 7, even at the end of discharge of the lithium ion secondary battery, the Li—In—Sn alloy layer was maintained between the solid electrolyte layer and the Li—Mg alloy layer. Since the shrinkage and interfacial delamination of the Li—In—Sn alloy layer is less likely to be potentially caused compared to the Li—Mg alloy layer, the Li—In—Sn alloy layer functions as an interface layer maintaining a solid-solid interface. Compared to the case where the Li—In—Sn alloy layer is not present, a reductive decomposition reaction of the solid electrolyte layer by Li can be prevented, and an increase in interface resistance and cell resistance can be suppressed. Also, there are two possible reasons why the Li—In—Sn alloy layer is more suitable as a protection layer than a Li—In alloy layer and a Li—Sn alloy layer.

The first reason is as follows. The melting point of Li—In—Sn alloy is lower than that of Li—In alloy and Li—Sn alloy, and the Li—In—Sn alloy is softer than Li—In alloy and Li—Sn alloy at the same operation temperature. Accordingly, the adhesion between the solid electrolyte layer and the anode layer during discharge in which Li is deintercalated from the anode layer, and the adhesion between the Li—In—Sn alloy layer and the Li—Mg alloy layer both improve; the resistance of the interface between the solid electrolyte layer and the anode layer decreases; and an improvement in charge rate characteristics is obtained.

The second reason is that the lithium ion conductivity of Li—In—Sn alloy is higher than that of Li—In alloy and Li—Sn alloy.

### REFERENCE SIGNS LIST

10. Cathode current collector
20. Cathode layer
30. Electrolyte layer
40. In—Sn alloy layer
41. Li—In—Sn alloy layer
50. Mg metal layer
51. Li—Mg alloy layer
60. Anode current collector
100. Lithium ion secondary battery
200. Lithium ion secondary battery

1. A lithium ion secondary battery,
wherein the lithium ion secondary battery uses a lithium metal precipitation-dissolution reaction;
wherein the lithium ion secondary battery comprises a cathode layer, an anode layer, and an electrolyte layer disposed between the cathode layer and the anode layer;
wherein the cathode layer contains a cathode active material that can occlude and release a lithium ion; and
wherein the anode layer contains a Mg element, an In element, a Sn element and a Li element.

2. The lithium ion secondary battery according to claim 1, wherein a molar ratio (Sn/In) of the Sn element to the In element contained in the anode layer is 0.5 or more and 3.8 or less.

3. The lithium ion secondary battery according to claim 1, wherein the anode layer comprises, in the order closest to the electrolyte layer side, a Li—In—Sn alloy layer containing a Li—In—Sn alloy and a Li—Mg alloy layer containing a Li—Mg alloy.

4. The lithium ion secondary battery according to claim 1,
wherein the lithium ion secondary battery comprises an anode current collector on the opposite side of the electrolyte layer of the anode layer, and
wherein, when the anode layer is divided into two equal parts in parallel to a laminated surface of the anode layer and an anode current collector-side region and an electrolyte layer-side region are determined as a first region and a second region, respectively, a content of the In and Sn elements in the second region of the anode layer is larger than a content of the In and Sn elements in the first region of the anode layer.

5. The lithium ion secondary battery according to claim 1, wherein the electrolyte layer is a solid electrolyte layer containing a sulfide-based solid electrolyte.

6. A lithium ion secondary battery,
wherein the lithium ion secondary battery uses a lithium metal precipitation-dissolution reaction;
wherein the lithium ion secondary battery comprises a cathode layer, an anode layer, and an electrolyte layer disposed between the cathode layer and the anode layer;
wherein the cathode layer contains a cathode active material that can occlude and release a lithium ion; and
wherein the anode layer comprises, in the order closest to the electrolyte layer, an In—Sn alloy layer containing an In—Sn alloy and a Mg metal layer containing elemental Mg.
